(19) United States
(12) Patent Application Publication
(10) Pub. No.: US 2017/0109372 A1
(43) Pub. Date: Apr. 20, 2017

(54) FILE ACCESS SYSTEM, METHOD, AND PROGRAM

(71) Applicant: NEC CORPORATION, Tokyo (JP)

(72) Inventor: Makoto SHIMAMOTO, Tokyo (JP)

(73) Assignee: NEC CORPORATION, Tokyo (JP)

(21) Appl. No.: 15/287,907

(22) Filed: Oct. 7, 2016

(30) Foreign Application Priority Data
Oct. 15, 2015 (JP) 2015-203625

(51) Int. Cl. G06F 17/30

(52) U.S. Cl. CPC G06F 17/30233

(57) ABSTRACT

To make it easier to access a file in a file system in a virtual container instance without starting up the virtual container instance. A file access system according to the present invention includes a logical volume including a storage area where perpetuated data of a virtual container instance is stored, reception means for receiving an operation command for a predetermined file path in a first file system in the virtual container instance, and access process means for making the storage area accessible from a second file system and executing the operation command through the second file system.

### INCORPORATION BY REFERENCE

This application is based upon and claims the benefit of priority from Japanese patent application No. 2015-203625, filed on Oct. 15, 2015, the disclosure of which is incorporated herein in its entirety by reference.

### BACKGROUND OF THE INVENTION

1. Technical Field

The present invention relates to a file access system, a method, and a program. In particular, the present invention relates to a file access system, a method, and a program for accessing a file in a virtual container instance.

2. Background Art

In recent years, owing to the spread of a virtual container technique (LXC (Linux (Registered Trademark) Containers)) typified by Docker (Registered Trademark), it has become possible to distribute an environment (middleware or library) on which an application is dependent as a binary-format image file and thereby to improve the transport capability of the application. To eliminate environmental dependence on a host OS (Operating System), a virtual container base operates a process in a virtual container instance environment as a process in a name space isolated from the host OS.

Note that Japanese Unexamined Patent Application Publication No. 2012-079245 (Patent Literature 1) discloses a technique in which a virtual disk volume having a size specified by a supervisor of a computer is allocated to a virtual machine and the virtual machine accesses the virtual disk volume without an intervention by a hypervisor. Further, European Patent Application Publication No. 2234018 (Patent Literature 2) discloses a technique for performing, from a backup server, an NFS (Network File System) operation for a file in a virtual file system which is connected to the backup server by an NFS in advance. Further, United State Patent Application Publication No. 2010/0050173 (Patent Literature 3) discloses a technique for allocating a resource cut out from a cloud computing system to a client environment.

It should be noted that the virtual container technique has a problem that it is very difficult to access a file in a file system in a virtual container instance without starting up the virtual container instance. The reason for this is explained hereinafter.

Firstly, in common virtual container base software, it is necessary to perform management and operation through an API (Application Programming Interface) released in the base software after going through several prerequisite procedures in order to eliminate the above-described environmental dependence. For example, when a simple file rewriting operation is performed, it is necessary to perform a process for starting up a virtual container instance from a virtual container image, an entry process to the virtual container instance, the intended process (i.e., the file rewriting process), a process for stopping the virtual container instance, and finally a process for reflecting (i.e., incorporating) the change (i.e., the rewriting) into the virtual container image to perpetuate the change. Therefore, it is necessary to perform the above-described management and operation for the virtual container instance in order to access the file in the file system in the virtual container image, which is very troublesome.

Further, a file in a file system in a virtual container instance environment, e.g., in a virtual container instance is virtually isolated from a host environment (a host OS) in which the virtual container base is operated. Therefore, it is impossible to access a file in a file system in a host OS from a virtual container instance environment by using a command provided by the host OS or to directly access a file in a file system in the virtual container instance from the host OS. Therefore, it is necessary to use an API provided by the virtual container or indirectly perform a file operation through a network or the like, which is very troublesome.

Note that the techniques disclosed in Patent Literature 1 to 3 relate to a virtual machine (VM) and hence cannot solve the above-described problem related to the virtual container.

### SUMMARY

The present invention has been made to solve the above-described problem and an object thereof is to provide a file access system, a method, and a program for making it easier to access a file in a file system in a virtual container instance without starting up the virtual container instance.

In a first exemplary aspect of the invention,

a file access system includes:

a logical volume including a storage area where perpetuated data of a virtual container instance is stored;

reception means for receiving an operation command for a predetermined file path in a first file system in the virtual container instance; and

access process means for making the storage area accessible from a second file system and executing the operation command through the second file system.

In a second exemplary aspect of the invention,

a file access method includes:

receiving an operation command for a predetermined file path in a first file system in a virtual container instance;

making a storage area accessible from a second file system, the storage area being an area included in a logical volume where perpetuated data of the virtual container instance is stored; and

executing the operation command through the second file system.

In a third exemplary aspect of the invention,

a file access program causes a computer to execute:

a process of receiving an operation command for a predetermined file path in a first file system in a virtual container instance;

a process of making a storage area accessible from a second file system, the storage area being an area included in a logical volume where perpetuated data of the virtual container instance is stored; and

a process of executing the operation command through the second file system.

The above and other objects, features and advantages of the present invention will become more fully understood from the detailed description given herein below and the accompanying drawings which are given by way of illustration only, and thus are not to be considered as limiting the present invention.

### BRIEF DESCRIPTION OF THE DRAWINGS

FIG. 1 is a block diagram showing an overall configuration of a file access system according to a first exemplary embodiment of the present invention;

FIG. 2 is a flowchart for explaining a file access process flow according to the first exemplary embodiment of the present invention;

FIG. 3 is a block diagram showing a configuration of a host computer according to a second exemplary embodiment of the present invention;

FIG. 4 shows an example of virtual container image information according to the second exemplary embodiment of the present invention;

FIG. 5 shows an example of device configuration information according to the second exemplary embodiment of the present invention;

FIG. 6 shows an example of a device pool name according to the second exemplary embodiment of the present invention;

FIG. 7 shows an example of mount point information according to the second exemplary embodiment of the present invention;

FIG. 8 is a flowchart for explaining a file access process flow according to the second exemplary embodiment of the present invention;

FIG. 9 shows an example of a file access command according to the second exemplary embodiment of the present invention; and

FIG. 10 is a block diagram showing a configuration of a file access system according to a third exemplary embodiment of the present invention.

### EXEMPLARY EMBODIMENT

Specific exemplary embodiments to which the present invention is applied are explained hereinafter in detail with reference to the drawings. The same components are denoted by the same symbols throughout the drawings, and duplicated explanation is omitted as necessary for clarifying the explanation.

### First Exemplary Embodiment

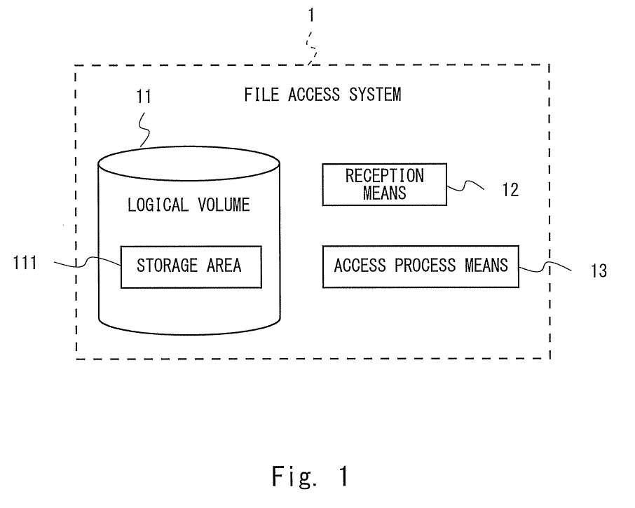

FIG. 1 is a block diagram showing an overall configuration of a file access system 1 according to a first exemplary embodiment of the present invention. The file access system 1 includes a logical volume 11, reception means 12, and access process means 13. The logical volume 11 includes a storage area where perpetuated data of a virtual container instance is stored. Here, it is assumed that the perpetuated data of the virtual container instance can be accessed through a first file system in the virtual container instance. Further, the logical volume 11 is a storage area for using a physical device area formed by at least one storage device as at least one logical disk. Note that the file access system 1 according to the first exemplary embodiment of the present invention should include at least one logical volume. Further, the perpetuated data of the virtual container instance is image data of the virtual container instance. That is, the image data of the virtual container instance is stored in a part of the area cut out from the logical volume 11. Therefore, when the virtual container instance is started up from the virtual container base, for the above-described storage area in the logical volume 11, it is possible to access a predetermined directory and a file in the first file system by the virtual container instance. Meanwhile, in general, it is impossible to directly access an area in the logical volume 11 through a later-described second file system such as a host OS.

The reception means 12 receives an operation command for a predetermined file path in the first file system in the virtual container instance. The access process means 13 makes the aforementioned storage area accessible from the second file system and executes an operation command through the second file system.

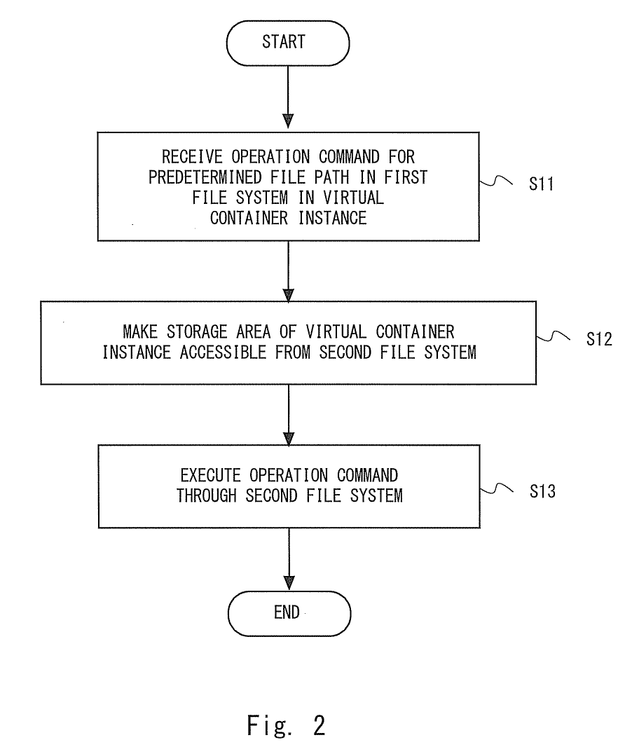

FIG. 2 is a flowchart for explaining a file access process flow according to the first exemplary embodiment of the present invention. Firstly, the reception means 12 receives an operation command for a predetermined file path in a first file system in a virtual container instance (S11). Next, the access process means 13 makes a storage area included in a logical volume in which perpetuated data of the virtual container instance is stored accessible from a second file system (S12). Then, the access process means 13 executes the operation command received in the step S11 through the second file system (S13).

As described above, according to the first exemplary embodiment of the present invention, the access process means 13 makes the storage area of the logical volume 11 in which perpetuated data of the virtual container instance is stored accessible from the second file system different from the first file system in the virtual container instance. Therefore, it is possible to execute an operation command for a predetermined file path in the first file system through the second file system. Consequently, it is possible to make it easier to access a file in a file system in the virtual container instance without requiring starting up of the virtual container instance.

### Second Exemplary Embodiment

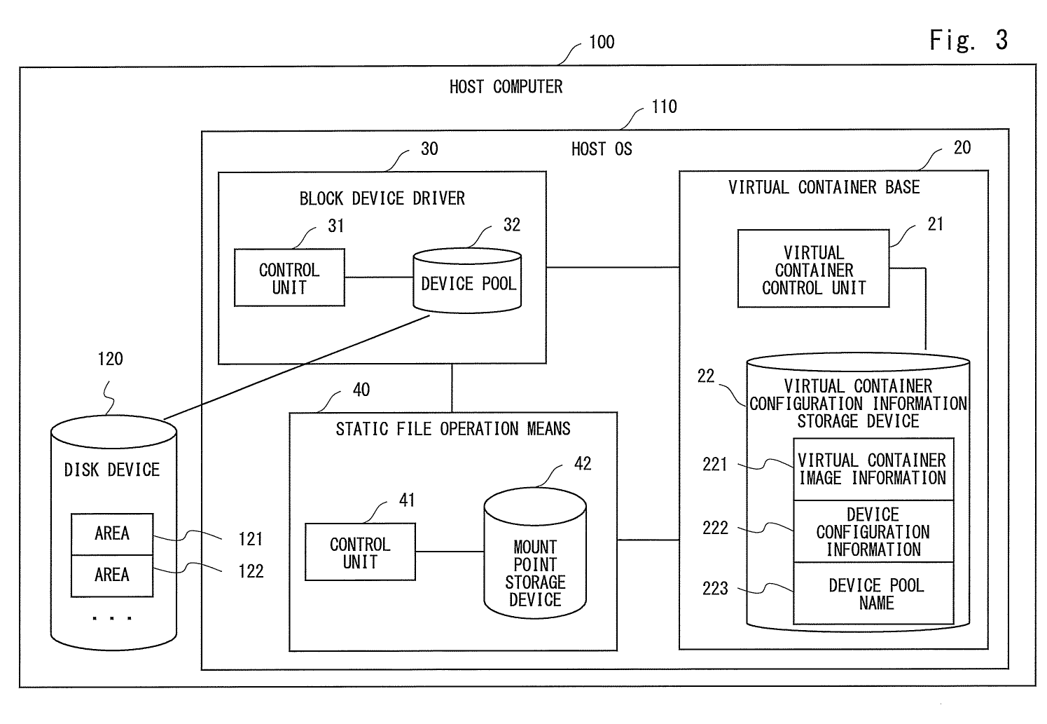

FIG. 3 is a block diagram showing a configuration of a host computer 100 according to a second exemplary embodiment of the present invention. It is assumed that in the host computer 100, virtual container base software is installed in a specific host OS environment and at least one container image is already created by a user in this environment. In the following example, it is assumed that a Docker is used as a virtual container base and a Devicemapper is used as a block device driver. Further, it is assumed that a system call IOCTL is used as operation means for the Devicemapper. Further, a thin-pool is used as mapping means for a device table by the Devicemapper.

The host computer 100 includes a host OS 110 and a disk device 120. The host computer 100 is a general-purpose computer. Since its hardware configuration is well-known, its detailed explanation is omitted. Note that FIG. 3 shows the host computer 100 as functional blocks.

The disk device 120 is divided into a plurality of areas such as areas 121, 122, . . . . Note that the host computer 100 should include at least one disk device. Various types of data used in the host computer 100 are stored in the area 121 and the like. In this example, it is assumed that the area 121 is mounted on a file system of the host OS 110 and the area 122 is not mounted on the file system of the host OS 110. Further, it is assumed that image data of a virtual container instance is stored in the area 122.

The host OS 110 includes a virtual container base 20, a block device driver 30, and static file operation means 40.

The block device driver 30 includes a control unit 31 and a device pool 32. The control unit 31 is driver software for controlling access to a block device by the host OS 110. The control unit 31 makes a specific area of the device pool 32 available as a logical device based on information about a device ID, a size, and a pool name delivered through an IOCTL function.

The device pool 32 is an area in which a physical device area is converted into (or defined as) a logical volume in advance by a user through the control unit 31. The device pool 32 manages the physical device area of the disk device 120 such as the area 122 as a logical device. A device ID is assigned to each logical device. Further, the device pool 32 is a storage area that is obtained by cutting out a specific area from a logical volume area according to the user's request and can be used as a logical device.

The virtual container base 20 includes a virtual container control unit 21 and a virtual container configuration information storage device 22. The virtual container control unit 21 is software including a command interface for receiving a process request from a user. Further, in response to a command such as a start, a stop, and perpetuation of a virtual container, the virtual container control unit 21 accesses image data which is perpetuated data of a virtual container instance stored in the device pool 32 managed by the block device driver 30 by using information stored in the virtual container configuration information storage device 22. Further, the virtual container control unit 21 creates a snapshot of the virtual container instance through the block device driver 30 based on the accessed image data, mounts it on a specific directory in the file system of the host OS 110, generates the virtual container instance, and allocates it as a file system accessible from the generated virtual container instance.

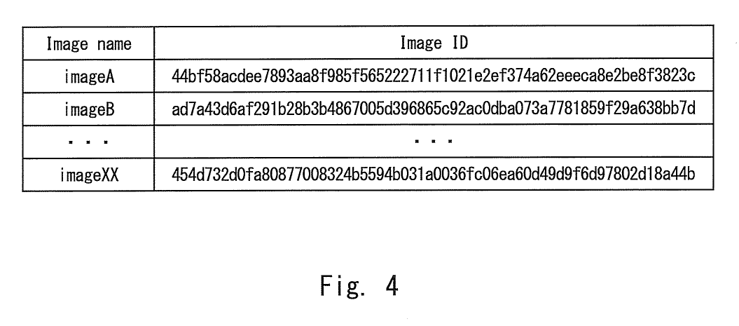

The virtual container configuration information storage device 22 stores therein virtual container image information 221, device configuration information 222, and a device pool name 223. FIG. 4 shows an example of the virtual container image information 221 according to the second exemplary embodiment of the present invention. The virtual container image information 221 is perpetuated data in which image names of virtual container instances created by a user (hereinafter referred to as “virtual container image names”) are associated with image IDs (hereinafter referred to as “virtual container image IDs”). The virtual container image names and the virtual container image IDs are examples of identification information of virtual container instances.

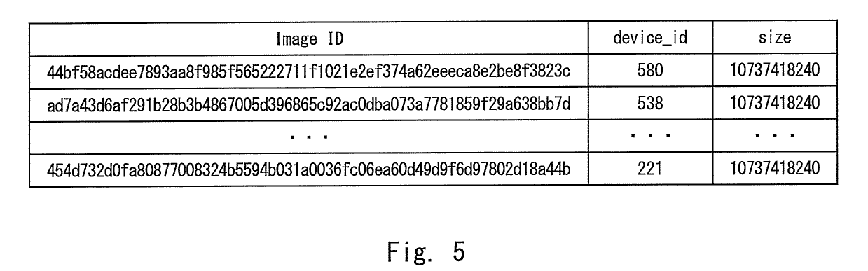

FIG. 5 shows an example of the device configuration information 222 according to the second exemplary embodiment of the present invention. The device configuration information 222 is perpetuated data in which virtual container image IDs, device IDs, and sizes are associated with each other. Note that the device ID is information for specifying a logical device managed by the device pool 32. The size is information indicating the amount (or size) of perpetuated data in a logical device having a corresponding device ID.

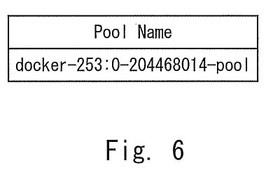

FIG. 6 shows an example of the device pool name 223 according to the second exemplary embodiment of the present invention. The device pool name 223 is a name of a device pool that the virtual container base 20 creates through the block device driver 30.

The static file operation means 40 includes a control unit 41 and a mount point storage device 42. The control unit 41 is an example of the above-described reception means 12 and the access process means 13. The control unit 41 receives a file access command from a user. The arguments of the file access command include a virtual container image name to be operated and a command line image. The command line image includes a file path specified by a predetermined directory and a file in a file system in a virtual container instance and an operation command for that file path.

The control unit 41 refers to the virtual container image information 221 stored in the virtual container configuration information storage device 22 and acquires a virtual container image ID associated with the received virtual container image name. In other words, the control unit 41 converts the virtual container image name into a corresponding virtual container image ID. After that, the control unit 41 determines a file system mount point destination of the virtual container instance by using the virtual container image ID and stores the determined file system mount point destination in the mount point storage device 42.

Further, the control unit 41 refers to the device configuration information 222 stored in the virtual container configuration information storage device 22 and acquires a device ID and a size associated with the received virtual container image name. In addition, the control unit 41 also acquires the device pool name 223 stored in the virtual container configuration information storage device 22. After that, the control unit 41 specifies an area in the device pool 32 through an IOCTL function by using the device pool name 223, the device ID, and the size. Then, the control unit 41 requests the block device driver 30 to makes the specified area available as a logical device. Further, the control unit 41 mounts the available logical device on the mount point destination stored in the mount point storage device 42.

After the completion of the mounting, the control unit 41 executes the command line image received from the user. After the execution, the control unit 41 unmounts the logical device from the mount point destination, invalidates the logical device, and deletes information about the mount point from the mount point storage device 42.

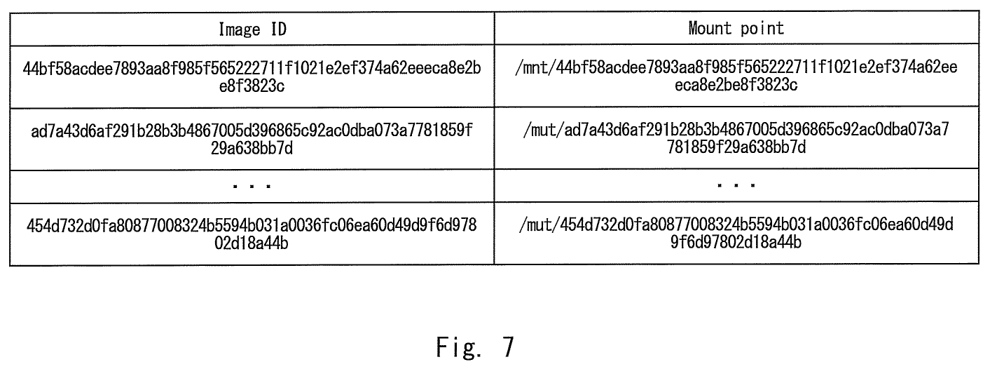

The mount point storage device 42 stores the mount point determined by the control unit 41. FIG. 7 shows an example of mount point information according to the second exemplary embodiment of the present invention. The mount point information is perpetuated data in which the image ID of the virtual container instance is associated with the mount point destination.

It should be noted that this exemplary embodiment can be expressed as follows. That is, the access process means mounts at least the storage area on a predetermined mount point and executes the operation command for the mount point. As described above, by mounting a storage area of a virtual container image that originally cannot be accessed from the second file system, it becomes possible to access it through the received file path.

Further, the reception means preferably receives identification information of the virtual container instance, and the access process means preferably generates the mount point based on the identification information and mounts the storage area on the generated mount point. In this way, it is possible to access the storage area through a unique mount point corresponding to the target virtual container instance.

Further, this exemplary embodiment preferably further includes storage means for storing area specifying information indicating the storage area in the logical volume, and the access process means preferably makes a storage area specified by the area specifying information available as a logical device, mounts the available logical device on the mount point, and executes the operation command for the mount point.

Furthermore, the access process means preferably unmounts the logical device from the mount point and invalidates the logical device after the execution of the operation command. In this way, the process is completed by executing one file access command and the file system is restored to the original state (i.e., the state before the above execution). Therefore, other processes (such as a virtual container starting up process performed after the above process) are not affected.

Further, the reception means preferably receives an update command for updating the predetermined file path as the operation command and the access process means preferably reflects the content updated by the execution of the operation command in the storage area. In this way, it is possible to perpetuate the container image without starting up the virtual container instance, thus eliminating the need for a snapshot and making it possible to prevent the deterioration of file I/O.

Further, the reception means receives the operation command in a host environment in which a process for the second file system is performed, and the access process means executes the operation command in the host environment. In this way, it is possible to access a file in the virtual container instance from the environment different from the virtual container instance without starting up the virtual container instance.

Further, the access process means preferably executes the operation command when the virtual container instance is not started up. The exclusive control like this can secure safety when the file access command is executed.

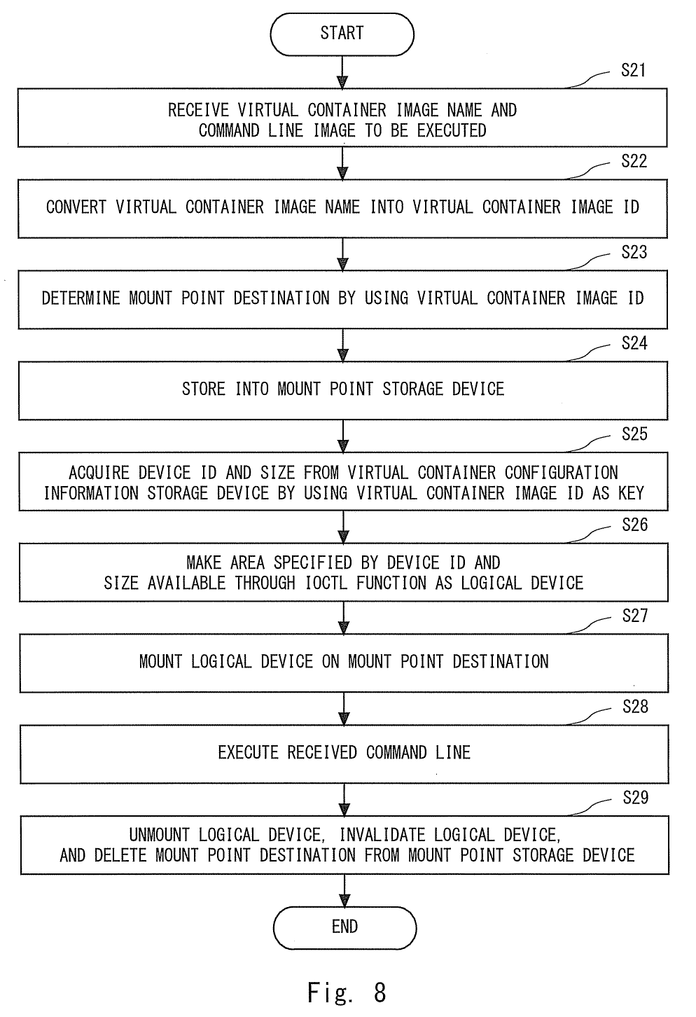

FIG. 8 is a flowchart for explaining a file access process flow according to the second exemplary embodiment of the present invention. Here, an example in which a specific file in a specific directory in a file system unfolded in a virtual container image is copied in a virtual container image specified by an image ID of a specific virtual container instance is explained.

It is assumed that an area of the device pool 32 is created in advance when an environment of the virtual container base 20 is constructed so that the virtual container base 20 can store a virtual container image. Further, it is assumed that the area of the device pool 32 is specified by a unique pool name “docker-253:0-204468014-pool”. Further, in the below explanation, it is assumed that a virtual container image specified by a virtual container name “ImageA” is constructed on the virtual container base 20. Further, it is assumed that data shown in FIGS. 4 to 6 is registered in the virtual container configuration information storage device 22. Further, it is assumed that in a period in which a logical device in which a container image is mapped is mounted on a specific path, exclusive control is performed for that logical device by an OS or a Devicemapper. Further, it is assumed no directory or file named “/opt/dir/fileA” exists under the management of the file system of the host OS.

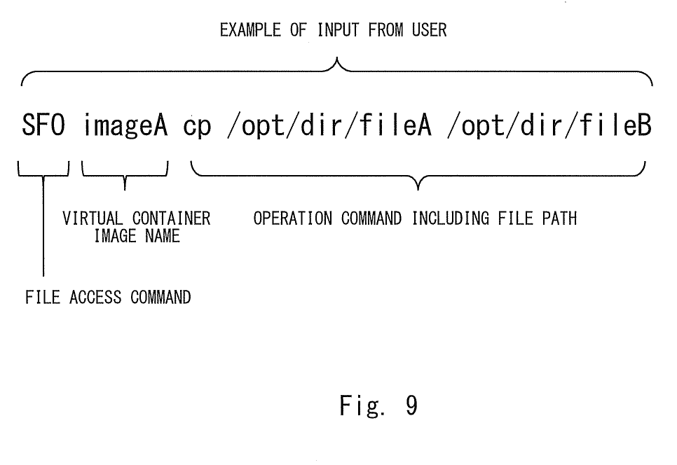

Firstly, a user enters a file access command whose arguments are a virtual container image name and a command line image to be executed through the static file operation means 40. Here, FIG. 9 shows an example of the file access command according to the second exemplary embodiment of the present invention. In this example, “SFO” is an example of the file access command according to the second exemplary embodiment of the present invention. Further, “ImageA” is a virtual container image name and “cp/opt/dir/fileA /opt/dir/fileB” is a command line image in a virtual container instance environment. Further, “cp” is an example of the above-described operation command and is a command of the host OS. Further, file paths “/opt/dir/fileA” and “/opt/dir/fileB” are examples of predetermined file paths (from a root directory) in a file system in the virtual container instance specified by “ImageA”.

Note that the command line image to be executed is a command line that cannot be executed unless various procedures are carried out after the virtual container instance specified by “ImageA” is started up under normal circumstances. Therefore, at this stage, the host OS cannot access a file in the directory “/opt/dir” managed by the file system of the virtual container instance. Consequently, at this stage, the command “cp /opt/dir/fileA /opt/dir/fileB” cannot be directly executed on the host OS.

Note that even if a directory and a file named “/opt/dir/fileA” exist under the management of the file system of the host OS, they differ from a directory and a file under the management of the file system in the virtual container instance specified by the virtual container name “ImageA”. Therefore, a result of the execution of the command “cp /opt/dir/fileA /opt/dir/fileB” obtained at this stage differs from one intended by the user.

The control unit 41 receives the file access command, upon the entering thereof by the user, whose arguments are the virtual container image name and the command line image to be executed (S21). Then, the control unit 41 refers to the virtual container configuration information storage device 22 and acquires a virtual container image ID “44bf58acdee7893aa8f985f565222711f1021e2ef374a62eeeca8e2be8f3823c” associated with the virtual container image name “ImageA” from the virtual container image information 221. After that, the control unit 41 determines a mount point as “/mnt/44bf58acdee7893aa8f985f565222711f1021e2ef374a62eeeca8e2be8f3823c” based on the acquired virtual container image ID. At this point, when there is no path for the mount point destination, the control unit 41 creates a directory corresponding to the mount point destination. Then, the control unit 41 stores information about the mount point destination path in the mount point storage device 42 (S24).

Further, the control unit 41 acquires a value “580” of the device ID and a value “10737418240” of the size from the virtual container configuration information storage device 22 through the virtual container control unit 21 by using the virtual container image ID as a key (S25). Then, the control unit 41 makes an area in the device pool 32 where perpetuated data of the virtual container image “ImageA” is stored available as a logical device through an IOCTL function by using the device ID “580”, the size “10737418240”, and the pool name “docker-253:0-204468014-pool” stored in the virtual container configuration information storage device 22 as arguments (S26). Specifically, the block device driver 30 makes a designated area available as a logical device in accordance with a request obtained through the IOCTL. Then, the control unit 41 reads the mount point destination from the mount point storage device 42 and mounts the available logical device on the read mount point destination (S27). As a result, it is possible to access a file in the file system in the virtual container instance from the file system in the host OS.

After the completion of the mounting, the control unit 41 executes the command line “cp /opt/dir/fileA/opt/dir/fileB” entered by the user in the step S21 on the host OS (S28). As described above, since the root directory and its subordinate directories under the management of the file system in the virtual container instance are mounted on the mount point destination under the management of the file system in the host OS, it is possible to refer to (i.e., to access) a file in the file system in the virtual container instance through the file path designated in the aforementioned command line and access the file intended by the user. In particular, in this example, since the operation command is a command for copying a file provided by the host OS, it is possible to directly write a file at the copy destination for the image data of the virtual container instance specified by the virtual container name “ImageA” without starting up the virtual container instance.

After the completion of the process by the execution of the operation command, the control unit 41 unmounts and invalidates the logical device, and deletes the information about the mount point destination from the mount point storage device 42 in a successive manner (S29).

As for the cost that is required from the start-up of a virtual container instance to the perpetuating process according to this exemplary embodiment, by analyzing a device configuration for each virtual container image unfolded in a logical device by the virtual container base and mounting a file system of a specific virtual container image on a file system in a host OS, it is possible to access a file system that is isolated in a virtual container instance under normal circumstances without the intervention of the virtual container instance. That is, it is possible to access a file system in a virtual container image without going through the operation from the start-up of the virtual container instance to the perpetuation. Further, by directly mounting a file system of each virtual container image on a file system of a host OS, it is possible to directly handle a file by using a command of the host OS.

The feature that the deterioration of file I/O can be prevented by this exemplary embodiment is explained hereinafter. Firstly, in general, a snapshot mechanism of a logical volume is used as means for perpetually preserving contents changed by an operation performed for a file system in a virtual container instance as a new virtual container image. Therefore, a snapshot is created every time the perpetuating process of the virtual container instance is performed. A file system mechanism of a current-state virtual container base often uses a Union FS. Therefore, there is a tendency that the file I/O deteriorates as a result of the perpetuating process, i.e., as a result of the creation of a snapshot. That is, in the conventional virtual container environment, since a virtual container image is perpetuated by using a snapshot function of a logical volume, the deterioration of file I/O is caused due to the snapshot mechanism, though the usefulness of the virtual container image management is improved. Therefore, for users, management/operation means in which as few snapshots as possible are created is desired. However, at the present time, major virtual container base software does not include such means. Under such circumstances, this exemplary embodiment makes it possible to operate a file in a file system of a virtual container from a file system of a host OS. As a result, it becomes possible to perform perpetuation to a file system in a virtual container image without creating a snapshot. Consequently, it is possible to prevent the arising of the cause of the file I/O deterioration.

### Third Exemplary Embodiment

In the above-described second exemplary embodiment, an example in a single host computer is explained. In a third exemplary embodiment, an example in which image data of a virtual container instance exists in a host computer that differs from a host computer in which a mount point exists is explained.

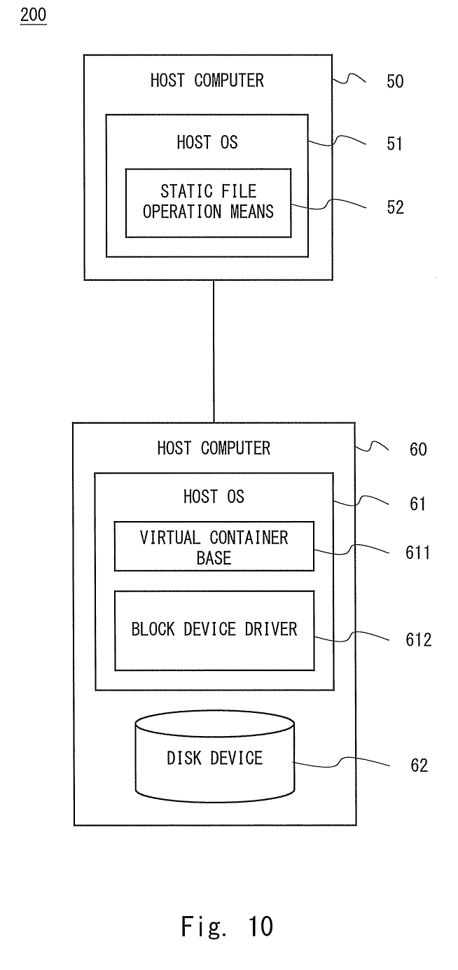

FIG. 10 is a block diagram showing a configuration of a file access system 200 according to the third exemplary embodiment of the present invention. The file access system 200 includes host computers 50 and 60. The host computer 50 includes a host OS 51 running therein and includes at least static file operation means 52. The static file operation means 52 has a configuration equivalent to that of the above-described static file operation means 40. However, the static file operation means 52 can access the host computer 60 through a network.

The host computer 60 includes a host OS 61 and a disk device 62. The host OS 61 includes at least a virtual container base 611 and a block device driver 612. The virtual container base 611 has a configuration equivalent to that of the above-described virtual container base 20 and the block device driver 612 has a configuration equivalent to that of the above-described block device driver 30. Further, the disk device 62 has a configuration equivalent to that of the above-described disk device 120.

When the static file operation means 52 receives a file access command like the one shown in FIG. 9 from a user, the static file operation means 52 specifies a virtual container image ID based on a virtual container image name from the virtual container base 611 through the network and determines a mount point destination under the management of a file system of the host OS 51. Further, the static file operation means 52 acquires a device ID, a size, and a device pool name based on the virtual container image ID from the virtual container base 611 through the network and makes a logical device available for the block device driver 612. After that, the static file operation means 52 mounts the available logical device on the determined mount point destination and executes an input command line. Then, after the execution, the host OS 51 unmounts the logical device, invalidates the logical device, and so on. As described above, the file access system 200 according to the third exemplary embodiment also provides advantageous effects similar to the above-described advantageous effects.

Note that only the essential functional blocks of the host computers 50 and 60 are shown in FIG. 10. However, the present invention is not limited to such a configuration. That is, the host computers 50 and 60 may have functions equivalent to each other and/or the roles of the host computers 50 and 60 may be interchanged with each other. Further, this exemplary embodiment may include three or more host computers.

### Other Exemplary Embodiments

Each of the exemplary embodiments according to the present invention can be regarded as a system that provides an isolated virtual container space in an environment constructed by the virtual container technique.

Note that the present invention is not limited to the aforementioned exemplary embodiments and may be changed as appropriate without departing from the spirit of the present invention.

Further, although the present invention is described as a hardware configuration in the above-described exemplary embodiments, the present invention is not limited to the hardware configurations. In the present invention, arbitrary processing can be also implemented by causing a CPU (Central Processing Unit) to execute a computer program.

In the above-described examples, the program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, a DVD (Digital Versatile Disc), a BD (Blu-ray (registered trademark) Disc), and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

The whole or part of the exemplary embodiments disclosed above can be described as, but not limited to, the following supplementary notes.

### (Supplementary Note 1)

A file access system comprising:

a logical volume including a storage area where perpetuated data of a virtual container instance is stored;

reception means for receiving an operation command for a predetermined file path in a first file system in the virtual container instance; and

access process means for making the storage area accessible from a second file system and executing the operation command through the second file system.

### (Supplementary Note 2)

The file access system described in Supplementary note 1, wherein the access processing means mounts the storage area on a predetermined mount point, and executes the operation command for the mount point.

### (Supplementary Note 3)

The file access system described in Supplementary note 2, wherein

the reception means receives identification information of the virtual container instance together with the operation command,

the access process means generates the mount point based on the identification information, and

the access process means mounts the storage area on the generated mount point.

### (Supplementary Note 4)

The file access system described in Supplementary note 2 or 3, further comprising storage means for storing area specifying information indicating the storage area in the logical volume, wherein

the access process means makes a storage area specified by the area specifying information available as a logical device, mounts the available logical device on the mount point, and executes the operation command for the mount point.

### (Supplementary Note 5)

The file access system described in Supplementary note 4, wherein the access process means unmounts the logical device from the mount point and invalidates the logical device after the execution of the operation command.

### (Supplementary Note 6)

The file access system described in any one of Supplementary notes 1 to 5, wherein

the reception means receives an update command for updating the predetermined file path as the operation command, and

the access process means reflects a content updated by the execution of the operation command in the storage area.

### (Supplementary Note 7)

The file access system described in any one of Supplementary notes 1 to 6, wherein

the reception means receives the operation command in a host environment in which a process for the second file system is performed, and

the access process means executes the operation command in the host environment.

### (Supplementary Note 8)

The file access system described in any one of Supplementary notes 1 to 7, wherein the access process means executes the operation command when the virtual container instance is not started up.

### (Supplementary Note 9)

A file access method comprising:

receiving an operation command for a predetermined file path in a first file system in a virtual container instance;

making a storage area accessible from a second file system, the storage area being an area included in a logical volume where perpetuated data of the virtual container instance is stored; and

executing the operation command through the second file system.

### (Supplementary Note 10)

A file access program for causing a computer to execute:

a process of receiving an operation command for a predetermined file path in a first file system in a virtual container instance;

a process of making a storage area accessible from a second file system, the storage area being an area included in a logical volume where perpetuated data of the virtual container instance is stored; and

a process of executing the operation command through the second file system.

According to the present invention, it is possible to provide a file access system, a method, and a program for making it easier to access a file in a file system in a virtual container instance without starting up the virtual container instance.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A file access system comprising:
a logical volume including a storage area where perpetuated data of a virtual container instance is stored;
a reception unit configured to receive an operation command for a predetermined file path in a first file system in the virtual container instance; and
an access process unit configured to make the storage area accessible from a second file system and execute the operation command through the second file system.

2. The file access system according to claim 1, wherein the access processing unit mounts the storage area on a predetermined mount point, and executes the operation command for the mount point.

3. The file access system according to claim 2, wherein
the reception unit receives identification information of the virtual container instance together with the operation command,
the access process unit generates the mount point based on the identification information, and
the access process unit mounts the storage area on the generated mount point.

4. The file access system according to claim 2, further comprising a storage unit configured to store area specifying information indicating the storage area in the logical volume, wherein
the access process unit makes a storage area specified by the area specifying information available as a logical device, mounts the available logical device on the mount point, and executes the operation command for the mount point.

5. The file access system according to claim 4, wherein the access process unit unmounts the logical device from the mount point and invalidates the logical device after the execution of the operation command.

6. The file access system according to claim 1, wherein
the reception unit receives an update command for updating the predetermined file path as the operation command, and
the access process unit reflects a content updated by the execution of the operation command in the storage area.

7. The file access system according to claim 1, wherein
the reception unit receives the operation command in a host environment in which a process for the second file system is performed, and
the access process unit executes the operation command in the host environment.

8. The file access system according to claim 1, wherein the access process unit executes the operation command when the virtual container instance is not started up.

9. A file access method comprising:
receiving an operation command for a predetermined file path in a first file system in a virtual container instance;
making a storage area accessible from a second file system, the storage area being an area included in a logical volume where perpetuated data of the virtual container instance is stored; and
executing the operation command through the second file system.

10. A non-transitory computer readable medium storing a file access program for causing a computer to execute:
a process of receiving an operation command for a predetermined file path in a first file system in a virtual container instance;
a process of making a storage area accessible from a second file system, the storage area being an area included in a logical volume where perpetuated data of the virtual container instance is stored; and
a process of executing the operation command through the second file system.
